(19) United States
(12) Patent Application Publication
(10) Pub. No.: US 2016/0196963 A1
(43) Pub. Date: Jul. 7, 2016

(54) System of devices and components of said system

(71) Applicant: Aldan Asanovich SAPARQALIYEV, Almaty (KZ)

(72) Inventors: Aldan Asanovich SAPARQALIYEV, Almaty (KZ); Kelis Maulenuly AKHMETOV, (US)

(21) Appl. No.: 14/906,634

(22) PCT Filed: Jun. 5, 2014
(86) PCT No.: PCT/KZ2013/000018

§ 371 Date: Jan. 21, 2016

(30) Foreign Application Priority Data
Jul. 22, 2013 (KZ) 2013/0972.1

(51) Int. Cl. H01J 41/12; H01F 10/18

(52) U.S. Cl. CPC H01J 41/12; H01F 10/18

(57) ABSTRACT

This invention relates to vacuum complex system of devices (VCSD), including, requiring vacuum the main unit (objects and processes, requiring a vacuum environment), a vacuum generating system. According to the invention, vacuum housing is designed in system form and constitutes an in-system vacuum chamber, comprising as follows: a unit of main device wherein a main device is arranged; at least, one unit of connected evacuating system wherein a connected evacuating system (CES) of vacuum generating system is arranged. CES is performed inside vacuum chamber of the main unit with taking into account the structural and functional characteristics of the main unit, and together they form a system VCSD. For initial rapid achievement of high vacuum inside the system chamber, it is used, together with CES, the system of external pumps, which is subsequently separated from VCSD via interface flange, and the vacuum condition in VCSD is supported by CES.

The present invention may be applied in fields such as electronics, systems of corpuscular optics, medicine, materials sciences etc.

New notions and terms used in this disclosure related mainly to novel objects proposed herein are explained in definitions included in the invention description, explanatory notes to drawings and in definitions of claims. Several such terms require supplemental explanations for their single-valued interpretation which are offered herein.

A connected gas evacuating system is defined as a connected evacuating system (CES), performed in an interactive mode with the main equipment in one integrate (in-system) housing configured as an in-system vacuum chamber.

A CES unit and a unit of main equipment are defined as units of in-system vacuum chamber and in-system housing wherein the CES and the housing are respectively arranged.

Arrangement of CES components relative to the perimeter of the main device is specified by degree of their jDP intersection, where values j=1,2,3,4 represent the CES environment reaching up 0.25%, 0.5%, 0.75%, 100% (of complete) side perimeter of the main device.

Arrangement of CES components relative to the side perimeter of gas-escape gate (to gas evacuating), between the unit of main equipment and CES unit, is specified by degree of their kTU-intersections, where values k=1,2,3,4 meet the case of the environment reaching up to CES 0.25%, 0.5%, 0.75%, 100% (of complete) side perimeter of the gas-escape gate.

A double-pole magnet axis is defined as a magnet axis, intersecting opposite magnet poles at the right angles.

There is known a vacuum complex system of devices (VCSD) comprising a main device arranged in a vacuum chamber of a vacuum housing; a vacuum generating system comprising, at least, one ions evacuating unit of pumping system.

To date a current vacuum generating system in complex with a main device forming a VCSD system is manufactured as a system of external pumps separately from a vacuum housing of a main device and does not consider its specific features, moreover they are connected by means of a standard flange.

One of examples of an external pump may be an ion pump with four asymmetrically arranged magnets in a vacuum housing of a pump, proposed in EP1863068 B1. Ions pump with asymmetrical magnetic field allows speeding up the vacuum chamber evacuating rate.

The main disadvantages of the VCSD with a constantly connected external pumping system are its top-heavy structure, considerable weight and low pressure in a vacuum chamber of main device (by two orders lower of magnitude) as compared to the pressure in a vacuum chamber of the external high-vacuum pump.

There are known the CES of 4DP-intersections, proposed in the EP2431996 A1 and EP2562786 A1.

The EP2431996 A1 proposed a CES with three connected evacuating units, arranged at intervals of 120 angular degrees, in a CES with hexagonal side perimeter. At that, each connected evacuating unit comprises two plate permanent magnets arranged one at each upper and lower sides of the CES unit. It comprises a group of cylindrical anodic electrodes and plate cathode electrodes arranged on the both its sides, straight across their axes.

The EP2562786 A1 proposed a circular CES, arranged in a CES unit with a rounded side perimeter wherein the CES with different inside and outside radii comprises two groups of plate ring-shaped electrodes, forming anodic and cathode groups, arranged coaxially, periodically alternating and in-parallel. Its magnetic system comprises a group of O¹-type magnets arranged, at least, in one of central and peripheral parts. Ring-shaped electrodes and O¹-type magnets are coaxially arranged and form a circular evacuating unit. Double-pole magnet axes are arranged in-parallel to each other and to common axis of circular evacuating unit. It should be noted that the O¹-type magnet is a single-layer and double-zone magnet.

The main disadvantages of known VCSD, proposed in EP2431996 A1 and EP2562786 A1 consist in the following:
They do not provide options to create VCSD 1DP-intersections, 2DP-intersections, 3DP-intersections;
They do not provide any potential multiform modes of performing and arranging electrodes and magnets, capable to meet numerous requirements to sizes and configurations of main device and vacuum level within an operating zone of the main device.
Inside path is performed of only one configuration, e.g., of just circular configuration;
A very restricted field of application is provided: e.g., to creating vacuum in accelerators on the way of charged particle flow.

A major objective of this invention is to propose a new VCSD type aimed at reducing its sizes, weight and at upgrading vacuum in main device units. The VCSD versions proposed in this invention cover all types of main device. Moreover this invention provides improved operating capabilities of main device, gained variability of VCSD types and enlarged fields of their applications.

The claimed VCSD meets the standards of invention, as any similar engineering solution was not identified on the filing date. There are substantial distinctions of herein proposed new VCSD from the known VCSD.

New proposed VCSD types may be implemented by means of available equipment using commercial materials, component parts and technologies.

To solve a basic objective of the present invention we propose new types of magnets for a device requiring a magnetic field to be applied.

The main distinction of proposed magnets types consists in that they are performed as comprising parallel arrangement of non-pole layers faced one another and selected from the group comprising the following: plate magnet; O^{1K}-type magnet, where 1K=2,3,4,. . . is a number of O¹-type layers in a magnet; G^{2K}-type magnet, where K=1,2,3,. . . is a number of G²-type layers in a magnet.

Other distinctions of proposed magnets types from the known magnets consist in that their G^{2K}-type magnets are performed being selected from the group comprising its configurations as follows: linear; continuously F-shaped; continuously H-shaped; one-break H-shaped; double-break H-shaped; asymmetrical three-break H-shaped; n -break polygonal-shaped; m-break curve-linear, including ellipsoidal and cylindrical configurations, where n=1, 2, 3,. . . and m=1, 2, 3,. . . is a number of breaks.

The main distinction of proposed VCSD from the known VCSD consists in that it is performed as comprising, at least, one particular distinction selected from the group comprising the following:

(a) Its vacuum housing is performed as an in-system vacuum housing and it constitutes an in-system vacuum chamber, comprising as follows: a unit of main device wherein a main device is arranged; at least, one unit of connected evacuating system wherein a connected evacuating system (CES) of vacuum generating system is arranged;

(b) At least, one evacuating unit of vacuum generating system comprises, at least, one of mentioned types of multilayer magnets.

Other distinctions of proposed VCSD from the known VCSD consist in the following:
Its CES is performed being selected from the group comprising its following intersections with the main device: jDP-intersections, where j=1,2,3,4;
Its in-system housing is performed being provided with a system of internal partitions (screens), performed with option to shielding the main device from electromagnetic radiation and screening it from dispersed metal waste generated by the CES, and comprises, at least, one gas-escape (to gas evacuating) gate, selected from the group comprising the modes as follows: with a simply connected section, with a doubly connected section, wherein each of them is selected from the group comprising the modes as follows: gas-escape gates of fixed sizes; at least, one of gas-escape gates of its in-system housing is performed with option of controlled change in cross-section (with diaphragm), in particular, to the zero point (closure), wherein a mode of change in cross-section provides the best configurations to maintaining required vacuum level in the unit of main device, as well as to ensuring required degree of main device safety from any CES magnetic field and dispersed waste generated in process of the CES operation;
its CES is performed being selected from the group comprising the modes of its intersections with a gas-escape gate as follows: kTU—intersections, where k=1,2,3,4;
its vacuum generating system comprises electrodes of cathode and anode systems which configurations and arrangements relative to each other are performed with option to forming an electron flow between the anodic and cathode electrodes, and they are performed being selected from the group comprising the modes as follows: a plate cathode electrode arranged in parallel and, at least, one plate anodic electrode; plate anodic electrodes and plate cathode electrodes are arranged in parallel to each other and they alternate on a cyclic base; two groups of plate ring-shaped electrodes having different inside and outside radii, forming anodic and cathode groups, are arranged coaxially, periodically alternating and in-parallel; group of cylindrical anodic electrodes and, at least, one plate cathode electrode arranged on one of its two sides straight across their axes; at least, one cylindrical anodic electrode and cylindrical cathode electrode arranged inside of the last-mentioned cylindrical anodic electrode and coaxial to it;
its vacuum generating system comprises magnets system, x, y and z, which xy and yz planes are superposed in a reported Cartesian coordinate system respectively on a transversal and horizontal planes of the CES, and it is performed in xy-planar SCR-representation being selected from the group comprising the following: plate magnets (single-layer, multilayer), arranged symmetrically or anti-symmetrically relative to the xz plane; at least, in one of central and peripheral parts is arranged, at least, one O^{1K}-type magnet with O^{1K}⋄X-orientation, where 1K≧1; at least, one G^{2K}-type magnet, performed being selected from the group comprising SCR arrangements as follows:

(a) arranged, at least, on one of upper and lower parts and selected from the group comprising the following: with ⋄Y-orientation and with DZ-orientation;

(b) arranged, at least, on one of lateral sides, and selected from the group comprising the following: with ⋄X-orientation and with hZ-orientation;

(c) arranged, at least, on one of side ends, and selected from the group comprising the following: with DX-orientation and with hZ-orientation;

(d) arranged in a crosswise-middle mode, and selected from the group comprising the following: with DX-orientation and with hZ-orientation;

(e) arranged in a crosswise-middle mode and symmetrically relative to the plane xz, at least, two magnets, selected from the group comprising the following: with DX-orientation and with hZ-orientation;

(f) comprises, at least, two magnets selected from the above mentioned magnets: (a), (b), (c), (d) and (e);

(g) comprises, at least, four magnets, arranged in a asymmetric mode;
its vacuum generating system further comprises an external pumping system provided with at least, one external pump, performed separately from a connected vacuum generating subsystem and selected from the group comprising the following: fore vacuum pump and pump of fast fore-vacuum pump-down;
its vacuum generating system comprises, at least, one ions evacuating unit, performed being selected from the group comprising the following: implantation magnet (palladic and catalytic), absorption, sorption, o-discharge magnet;
its in-system vacuum housing performed with option to separating it from external pumping system through an interface flange, wherein the CES is performed with option to maintain required vacuum level in the main device of in-system housing of without any external pumping system;
interface flange of its in-system housing comprises, at least, one of vacuum insulation means to insulate its in-system vacuum chamber from the ambient environment performed being selected from the group comprising the following: magnetic valve, closure (vacuum cover flange).

This invention may be implemented in many versions, so only certain preferred embodiments are described by means of examples given in the supporting drawings explaining versions of the proposed engineering solutions

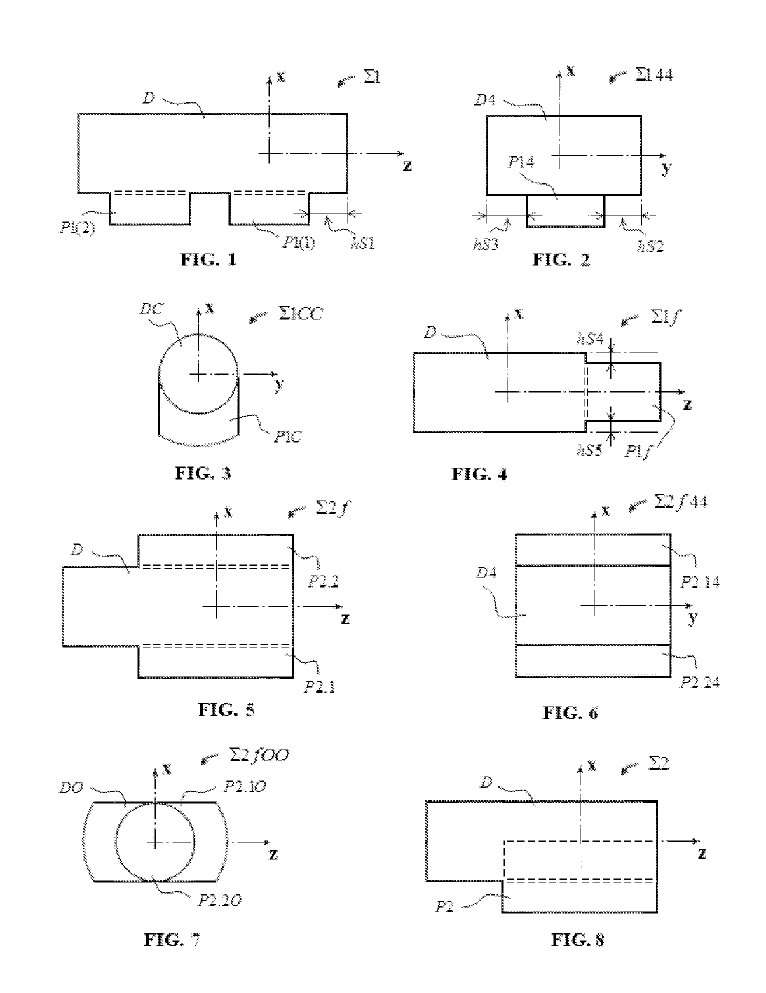

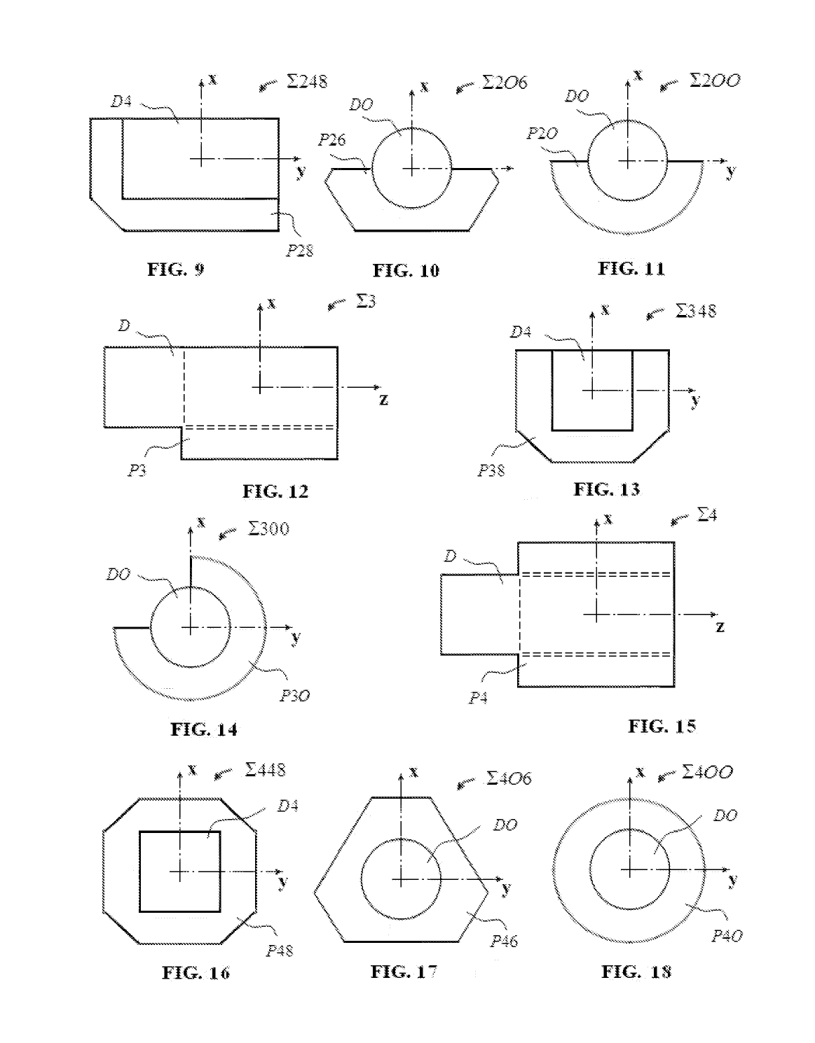

FIGS. 1-18 represent diagrams of some examples of in-system housing configuration and arrangement within a in-system vacuum chamber of main device and CES, specified by their jDP-intersections degree, where j=1,2,3,4:

In FIGS. 1-4, the examples of 1DP-intersections are shown;

In FIGS. 5-11, the examples of 2DP-intersections are shown, wherein FIGS. 5-7 represent the examples of arrangement on two opposite sides of the main device (2DPf-intersections), FIGS. 8-11 represent the examples of arrangement on two adjacent sides of the main device;

FIGS. 12-14 represent the examples of 3DP-intersections;

The limits of combined arrangement of the main device unit and the CES unit are designated by single dash lines. The boundary between the main device unit and CES unit is designated by double dash line. To designate the objects there are used a systematic approach and such designations are introduced as follows: D—main device; DO—main device with a cylinder-shaped perimeter; D4—main device with a quadrangular perimeter; Pj—type of CES components, suitable to its jDP—intersection; PjO—type Pj with suitable segment of cylinder-shaped perimeter; Pj4—type Pj, with suitable segment of quadrangular perimeter; Pj6—type Pj, with suitable segment of hexagonal perimeter; Pj8—type Pj, with suitable segment of octangular perimeter.

Example shown in FIG. 1 with two components P1 (1) and P1 (2) CES, separately arranged on one side of the main device along its length, emphasizes that it is possible to separately arrange several Pj, along the length of the main device. FIGS. 2-18 and next figures consider engineering solutions for one Pj, arranged along the length of the main device, which don't lose generality for several Pj, arranged along the length of the main device.

Each inter-edges spacing hS1 of main device unit and components of CES unit, shown in FIG. 1, hS2 and hS3 in FIGS. 2, hS4 and hS5 in FIG. 4 depends on system design features, in particular, at least, one of them may be equal to zero.

Arrangement of CES components in P1f mode, on the side end of the main device, shown in FIG. 4, is suitable for case where the main device has a short length. Arrangement of CES components in P2.1 and P2.2 modes on two opposite sides of the main device, shown in FIG. 5, and particular modes P2.14 and P2.24 shown in FIG. 6, as well as in particular modes P2.10 and P2.240 shown in FIG. 7, are suitable for cases where main device has a considerable width or diameter.

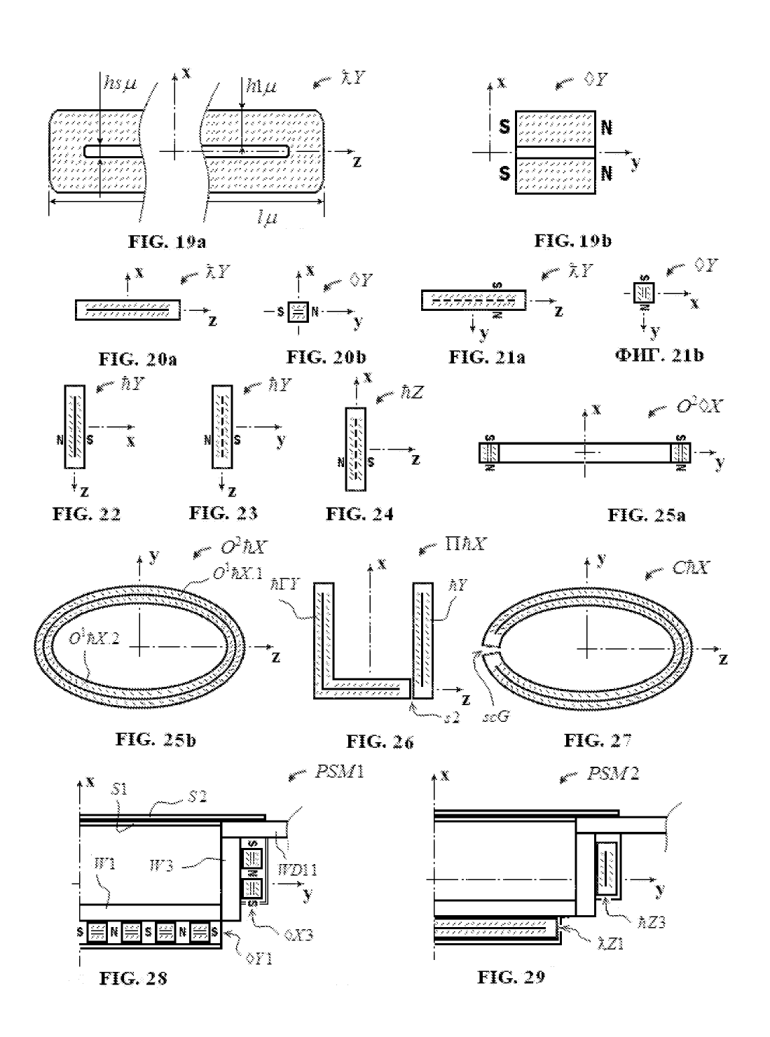

To create an efficient functioning light-weight and small-sized CES unit for different types of the main device this invention proposes a new magnet: multilayer magnet of diversiform types (types of multilayer magnets), performed as comprising parallel arrangement of non-pole layers faced one another. Multilayer magnet is notable for its higher field intensity as compared to known magnets given equal their dimensions. FIGS. 19a-27 represent diagrams of some examples of multilayer magnets implementation: structure formation, spacing orientations and poles orientations in a reported coordinate system.
FIGS. 19a-24 represent multilayer G^{2K}-type magnets, in a particular case, where 2K=2 and K=1, i.e., magnet has only two layers and it is formed by one G²-type magnet;
FIGS. 25a 25b represent a multilayer O^{1K}-type magnet, in a particular case, where 1K=2 and K=2, i.e., magnet has only two layers and it is formed by two double-zone O¹-type layers in a magnet.
FIGS. 26 and 27 show some optional implementations of G²-type magnets of nonlinear configurations.

In FIGS. 19a-27 for description simplicity we propose double-layer magnets. Certainly, they may contain over two layers.

In FIGS. 19a-27 and in next figures to describe magnets space orientations and their poles orientations in a reported coordinate system we used an in-system coordinate representation (SCR). For this purpose such designations are introduced as follows:
Symbols D, h and ⋄ designate their space orientations, associated with one of such types as follows: horizontal, vertical and cross-section;
Symbols X, Y and Z designate space orientations of their two-pole magnet axes parallel, respectively, to their rectilinear coordinate axes x, y and z;
Symbols O¹, O² and C designate, respectively, O¹-type magnet, O²-type magnet and curvilinear G²-type magnet;
Plate magnets are shown without similar symbols, as follows: O¹, O² and C.

FIGS. 19a-23 represent different projections of G²-type magnet a in Cartesian coordinates system x, y and z, which coordinate axes z and y are respectively parallel to horizontal axis of symmetry and two-pole magnet axis of the G²-type magnet shown in a SCR-representation:
FIGS. 19a and 19b represent a G²-type magnet, respectively in DY-orientations (magnet is arranged in horizontal with two-pole axis, in parallel to the Y coordinate axis) and in ⋄Y-orientations (magnet is shown in cross-section, at the same applied coordinates system).
In FIGS. 20a-23, a G²-type magnet is designated by schematic symbols in different projections in the same reported coordinates system.

Certainly, the coordinates system may be performed in any other mode relative to space magnet orientations. FIG. 24 represents a vertical position of G²-type magnet, for which Cartesian coordinates system x, y and z is introduced in the manner making it possible to represent the magnet in hZ-orientations (magnet is arranged vertically with a two-pole axis, parallel to the z coordinate axis). It should be noted that the G²-type magnet in itself is a double-layer magnet. As is shown in FIG. 19a, the gap width between the layers is small hs μ→0, wherein layer thickness is less than its length h1μp lμ.

FIGS. 25a and 25b represent the O²-type magnet consisting of two O¹-type layers in a magnet, respectively, in O²⋄X-orientation and in O²hX-orientation with components O¹hX.1 and O¹hX.2.

FIG. 26 represents in hΠY-orientation an optional implementation of G²-type magnet of Π-shaped configuration, consisting of a Γ-shaped magnet of hΓY-orientation and linear magnet of hY-orientation and with slit s2 between them. FIG. 27 represents in a ChX-orientation an optional implementation of G²-type magnet of curvilinear configuration wherein a slit s2G between its ends is shown.

FIGS. 28-44 illustrate a SCR-representation in schematic diagrams of some examples of CES unit implementation:
FIGS. 28-34 represent in cross-section of coordinates xy plane (xy-planar SCR-representation) examples of magnets system implementation;
FIGS. 35-44 represent, in a xz plane, examples of magnets system implementation symmetrically to the xy plane in combination with different types of electrodes system in the quadrangular CES units.

FIGS. 28-44, to determining magnets positions relative to the sides of the CES unit, the above mentioned designations of the SCR-representation are added with symbols i=1, 2, 3, 4, 5, 6, 7, where:

i=1 and 2 are respectively lower position on the far-out side of the main device and upper position on the opposite side to a lower side of the main device;

i=3 and 4 are respectively right and left lateral positions, perpendicular to the y coordinate axis;

i=5 and 6 are respectively right and left end-side positions, perpendicular to the z coordinate axis;

i=7 is a middle position relative to two opposite sides. For example, for a G^{2K}-type magnet the symbol hZ3 designates its right lateral position in the CES unit, and its hZ-orientation.

Symbol W, in combination with symbol i designates a wall of in-system housing, related to the CES unit, and to positions corresponding to the value of symbol i.

Breaking-down of some FIGS. 28-44 over the planes xy or xz, indicates that only a part of the figure symmetrical, respectively, to the plane xy or xz is shown.

FIGS. 28 and 29 represent the examples of magnets system implementation on the outside of CES unit, wherein, pursuant to the reported designation system: W3 and W1 are the walls of in-system housing, related to a right side wall and a lower wall of the CES unit; WD11 is one of the walls of an in-system housing, related to the main device unit; S1 and S2 are, respectively, the first and the second screens protecting the main device from magnetic fields and waste dispersed on the electrodes surfaces; ⋄X3 and ⋄Y1 are, respectively: ⋄X-orientation of magnets group, arranged on the right lateral side of the CES unit (⋄X3-arrangement) and ⋄Y orientations of magnets group, arranged on the lower side of the CES unit (⋄Y1-arrangement); hZ3 and DZ1 are, respectively: hZ3 magnets group arrangement and DZ1 magnets group arrangement.

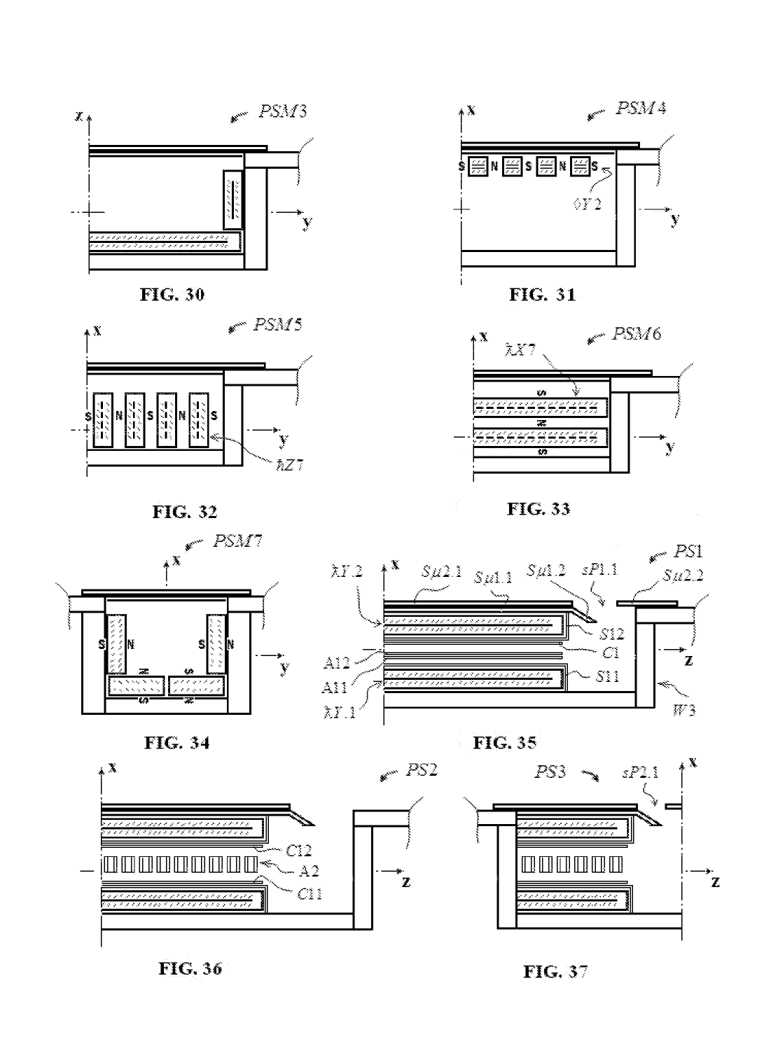

Certainly, the magnets system may be arranged on the inside of the CES unit of in-system housing. FIGS. 30 and 31 represent the examples of magnets system implementation on the inside of the CES unit, wherein ⋄Y2-⋄Y2 are arrangements of magnets group.

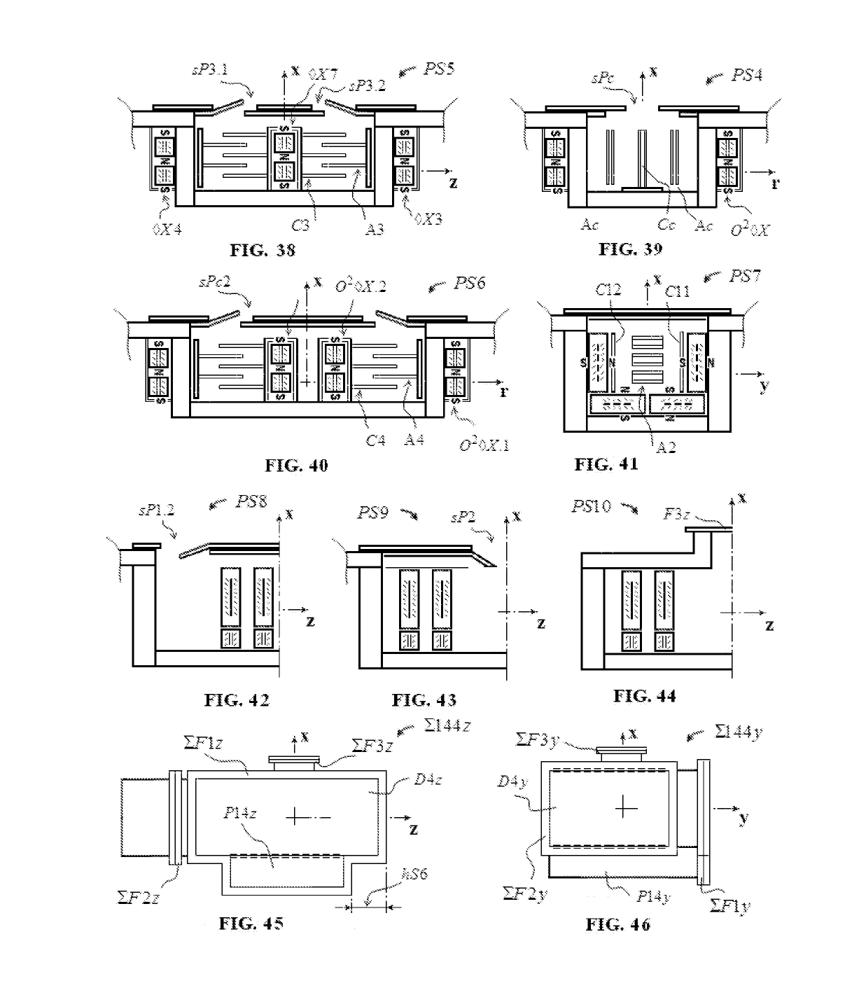

Arrangement of magnets groups in the CES unit may be performed in a crosswise-middle mode and selected from the group comprising the following: with DX-orientation and with hZ-orientation, i.e., in vertical or in horizontal arrangements shown, respectively in FIGS. 32 and 33. Wherein hZ7 and DX7 are, respectively, hZ7 magnets group arrangement and DX7 magnets group arrangement.

FIG. 34 represents an example of an asymmetric arrangement of four plate magnets in a CES unit.

FIGS. 35-38 represent examples of magnets system implementation in xz plane symmetrically relative to the plane xy in combination with different types of electrode systems in quadrangular CES units. Wherein designations are used as follows: W5 is a wall of in-system housing, corresponding to the right end-side wall of the CES unit; S1.1 and S1.2 are, respectively, planar and curved segments of the first and second protection screens S1; S2.1 and S2.2 are, respectively, the first and the second segments of the second protecting screen S2; DY1 and DY2 are, respectively, DY1 magnets group arrangement and DY2 magnets group arrangement; C1 is a plate cathode electrode; A11 and A12 are, respectively, the first and the second plate anodic electrodes; sP1.1 is a right gate of two gas-escape gates with a simply connected cross-section; C11 and C12 are, respectively, the lower and the upper plate cathode electrodes; A2 is a group of cylindrical anodic electrodes. FIG. 37 shows the case where there are no CES components between two gas-escape gates with a simply connected cross-section (one of them sP2.2 is shown).

FIG. 38 represents a version in implementing two lateral magnets groups of ⋄X3-arrangement, ⋄X4-arrangement and crosswise-middle magnets group of ⋄X7-arrangement in combination with system of plate anodic electrodes A3 and cathode electrodes C3, arranged in-parallel to each other and periodically alternating.

Arrangement of magnet systems of O^{1K}-type magnets and electrodes, shown in FIGS. 39 and 40, makes it possible to perform the CES unit in cylinder-shaped mode as well as in a quadrangular mode. FIGS. 39 and 40 represent in a xr plane, where: r=\sqrt{y²+z²}, represents examples of magnets system implementation coaxial to the axis X in combination with different types of electrodes systems. FIG. 39 represents electrodes of anode Ac and cathode Cc, performed coaxial in cylinder-shaped configuration; O²⋄X are O²⋄X-orientations of annular O²-type magnets group; gas-escape gate sPc with a simply connected cross-section. FIG. 40 represents groups of plate ring-shaped electrodes of anode A4 and cathode C4, arranged in-parallel to each other and periodically alternating; O²⋄X.1 and O²⋄X.2 designate, respectively, annular external and inside groups of O²-type magnets; gas-escape gate sPc2 with a doubly connected cross-section. In case of CES unit embodiments, shown in FIGS. 39 and 40, of quadrangular configuration their magnets and electrodes as well are shaped in a quadrangular configuration.

FIGS. 41-44 represent implementation examples of four G²-type magnets groups antisymmetrical relative to the plane xy. FIG. 41 represents in a cross-section over the XY plane one of CES implementation modes: C11 and C12 are, respectively, right and left plate cathode electrodes; where: A2 is a group of cylindrical anodic electrodes. Certainly other modes of electrodes implementation are feasible. So, FIG. 42 shows the case where between two gas-escape gates with simply connected cross-sections (one of them sP1.2 is shown) the CES unit is arranged; FIG. 43 shows the case where one gas-escape gate sP2 with a simply connected cross-section is provided; FIG. 44 shows the case where four groups of G²-type magnets, antisymmetrically arranged relative to the plane xy, are embodied in an individual housing (ion pump) with a connecting flange F3z .

It should be noted that an incurved segment of the screen may be performed as a valve with option to control the sizes of gas-escape gates.

FIGS. 45 and 46 represent one of in-system housing embodiment versions. FIG. 45 represents in a xz projection: quadrangular P14z block of the CES unit; quadrangular block D4z of the main device; flange ΣF3z connected to an external pumping system; crosswise flange ΣF2z; longitudinal flange ΣF1z. FIG. 46 represents in a xy projection: a quadrangular block P14y of the CES unit; quadrangular block D4y of the main device; flange ΣF3y connected to an external pumping system; crosswise flange ΣF2y; longitudinal flange ΣF1y.

Spacing hS6 between the edges of the main device unit and CES unit, indicated in FIG. 45, may be equal to zero.

1. A magnet for a device requiring application of a magnetic field wherein the said magnet is performed as comprising faced one another non-pole layers arranged in parallel and selected from the group comprising magnet types as follows: a plate magnet; O^{1K}-type magnet, where 1K=2,3,4,. . . is a number of O¹-type layers in a magnet; G^{2K}-type magnet, where K=1,2,3,. . . is a number of G²-type layers in a magnet.

2. The magnet for a device of claim 1, wherein its G^{2K}-type magnet is performed as selected from the group comprising its configurations as follows: linear; continuously F-shaped; one-break F-shaped; continuously H-shaped; one-break H-shaped; double-break H-shaped; asymmetrical three-break H-shaped; n -break polygonal-shaped; m-break curve-linear, including ellipsoidal and cylindrical configurations, where n=1, 2, 3,. . . and m=1, 2, 3, . . . is a number of breaks.

3. A vacuum complex system of devices (VCSD) comprising a main device arranged in a vacuum chamber of a vacuum housing; a vacuum generating system comprising, at least, one evacuating unit of pumping system wherein the said VCSD is performed as comprising, at least, one particular distinction selected from the group comprising the following:
a) its vacuum housing is performed as an in-system vacuum housing and it constitutes an in-system vacuum chamber, comprising the following: a unit of main device wherein a main device is arranged; and at least, one unit of connected evacuating system wherein a connected evacuating system (CES) of vacuum generating system is arranged;
b) at least, one evacuating unit of vacuum generating system comprises, at least, one of mentioned types of multilayer magnets.

4. The system of claim 3, wherein its CES is performed being selected from the group comprising its intersections with the main device as follows: jDP-intersections, where j=1,2,3,4 . . . .

5. The system of claim 4, wherein its in-system housing is performed being provided with a system of internal partitions (screens), performed with option to shielding the main device from electromagnetic field and screening it from dispersed metal waste generated by the CES, and comprises, at least, one gas-escape (to gas evacuating) gate, selected from the group comprising the modes as follows: with a simply connected cross-section, with a doubly connected cross-section, wherein each of them is selected from the group comprising the modes as follows: gas-escape gates of fixed sizes; at least, one of gas-escape gates of its in-system housing is performed with option of controlled change in cross-section (with diaphragm), in particular, to the zero point (closure), wherein a mode of change in cross-section provides the best configurations to maintaining required vacuum level in the unit of main device, as well as to ensuring required degree of main device safety from any CES magnetic field and dispersed waste generated in process of the CES operation.

6. The system of claim 5, wherein its CES its CES is performed being selected from the group comprising the modes of its intersections with a gas-escape gate as follows: kTU intersections, where k=1,2,3,4.

7. The system of claim 6, wherein its vacuum generating system comprises electrodes of cathode and anode systems which configurations and arrangements relative to each other are performed with option to forming an electron flow between the anodic and cathode electrodes, and they are performed being selected from the group comprising the modes as follows: a plate cathode electrode arranged in parallel and, at least, one plate anodic electrode; plate anodic electrodes and plate cathode electrodes are arranged in parallel to each other and periodically alternating; two groups of plate ring-shaped electrodes having different inside and outside radii, forming anodic and cathode groups, are arranged coaxially, periodically alternating and in-parallel; group of cylindrical anodic electrodes and, at least, one plate cathode electrode arranged on one of its two sides straight across their axes; at least, one cylindrical anodic electrode and cylindrical cathode electrode arranged inside of the last-mentioned cylindrical anodic electrode and coaxial to it;

8. The system of claim 7, wherein its vacuum generating system comprises magnets systems, x, y and z, which xy and yz planes are superposed in a reported Cartesian coordinates system respectively on a transversal and horizontal planes of the CES, and it is performed in xy-planar SCR-representation being selected from the group comprising the following: plate magnets (single-layer, multilayer), arranged symmetrically or anti-symmetrically relative to the xz plane; at least, one O^{1K}-type magnet with O^{1K}⋄X-orientation, where 1K≧1 arranged in one of central and peripheral parts; at least, one G^{2K}-type magnet, performed being selected from the group comprising SCR arrangements as follows:
(a) arranged, at least, on one of upper and lower parts and selected from the group comprising the following: with ⋄Y -orientation and with DZ-orientation;
(b) arranged, at least, on one of lateral sides, and selected from the group comprising the following: with ⋄X-orientation and with hZ-orientation;
(c) arranged, at least, on one of side ends, and selected from the group comprising the following: with DX-orientation and with hZ-orientation;
(d) arranged in a crosswise-middle mode, and selected from the group comprising the following: with DX-orientation and with hZ-orientation;
(e) arranged in a crosswise-middle mode and symmetrically relative to the plane xz, at least, two magnets, selected from the group comprising the following: with DX-orientation and with hZ-orientation;
(f) comprises, at least, two magnets selected from the above mentioned magnets: (a), (b), (c), (d) and (e);
(g) comprises, at least, four magnets, arranged in a asymmetric mode.

9. The system of claim 8, wherein its vacuum generating system further comprises an external pumping system provided with at least, one external pump, performed separately from a connected vacuum generating subsystem and selected from the group comprising the following: fore vacuum pump and pump of fast fore-vacuum pumping-down.

10. The system of claim 9, wherein its vacuum generating system comprises, at least, one ions evacuating unit, performed being selected from the group comprising the following: implantation magnet (palladic and catalytic), absorption, sorption, magnet-discharge ions pumping unit.

11. The system of claim 10, wherein its in-system vacuum housing is performed with option to separating it from external pumping system through an interface flange, wherein the CES is performed with option to maintain required vacuum level in the main device of in-system housing without any external pumping system.

12. The system of claim 11, wherein interface flange of its in-system housing comprises, at least, one of vacuum insulation means to insulate its in-system vacuum chamber from the ambient environment performed being selected from the group comprising the following: magnetic valve, closure (vacuum cover flange).
